(19) United States
(12) Patent Application Publication
(10) Pub. No.: US 2015/0373896 A1
(43) Pub. Date: Dec. 31, 2015

(54) Garden Tool

(71) Applicant: Bradley Martin, Stanwood, WA (US)

(72) Inventor: Bradley Martin, Stanwood, WA (US)

(21) Appl. No.: 14/280,617

(22) Filed: May 18, 2014

(51) Int. Cl. A01B 1/16; A01B 1/22

(52) U.S. Cl. CPC A01B 1/16; A01B 1/225

(57) ABSTRACT

The instant application discloses, among other things, a Gardening Tool. In one embodiment, Gardening Tool may comprise an elongated handle which may connect to a head by an offset bracket. The bracket may be offset at an angle such as approximately 45°, for example. The head may include a detachable U-shaped, double-edged blade which may rotate slightly, for example, at 8° to 12° angles, upon pushing and pulling motions. The head may include a plurality of spikes which may facilitate the process of breaking through weeds, roots, debris, or other matter at or below the surface of the soil, reducing labor time and costs and improving efficiency.

### FIELD

This disclosure relates to a gardening tool.

### BACKGROUND

Gardeners, farmers, and other laborers often experience difficulty breaking through roots, weeds, and other matter in the earth. The use of conventional tools such as rakes, picks, and hoes, for instance, typically require a user to expend a significant amount of time and energy to break through tough soil. Often times, this may result in high labor costs, muscle strain or injury to a user, or damage to existing crops, for instance.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, a Gardening Tool. In one embodiment, Gardening Tool may comprise an elongated handle which may connect to a head by a bracket. The bracket may have an offset of an approximate 45° angle, for example, in relation to the handle. The head may include a U-shaped double-edged blade. The blade may oscillate at any angle, for example, 8° to 12° relative to the bracket, upon both pushing and pulling motions to facilitate the destruction of matter at or below the surface of the soil, for instance. The blade may also be equipped with a plurality of spikes which may help loosen the soil at a deeper level plane than a basic blade, thus improving the efficiency of the labor.

In another embodiment, Gardening Tool may comprise an elongated handle connected to head including a wavy blade. The wave lengths may measure any distance such as 2 inches, for example. The wavy blade may also contain a plurality of spikes along its length.

Gardening Tool may be used for a variety of purposes such as cultivation, removal of weeds, moss or debris from gravel, soil, root material, and mulch areas, or leveling of plant or flower beds, among many other uses.

A person skilled in the art will understand that a Gardening Tool may be made in various shapes and sizes, and of various materials, such as wood, plastic, rubber, metal, or carbon fiber, for example.

Many of the attendant features may be more readily appreciated as they become better understood by reference to the following detailed description considered in connection with the attached drawings.

### BRIEF DESCRIPTION OF THE DRAWINGS

FIG. 1 is a perspective view of a Gardening Tool, according to one embodiment.

FIG. 2 is a perspective view of the head of a Gardening Tool, according to the first embodiment.

FIG. 3 is a side view of a Gardening Tool, according to the first embodiment.

FIG. 4 is a view of a Spike 150 according to the first embodiment.

FIG. 5 is a perspective view of a Gardening Tool, according to a second embodiment.

FIG. 6 is a side view of a Gardening Tool, according to the second embodiment.

FIG. 7 is a front view of a blade of a Gardening Tool, according to the second embodiment.

FIG. 8 is a view of a Spike 450 according to the first embodiment.

### DETAILED DESCRIPTION

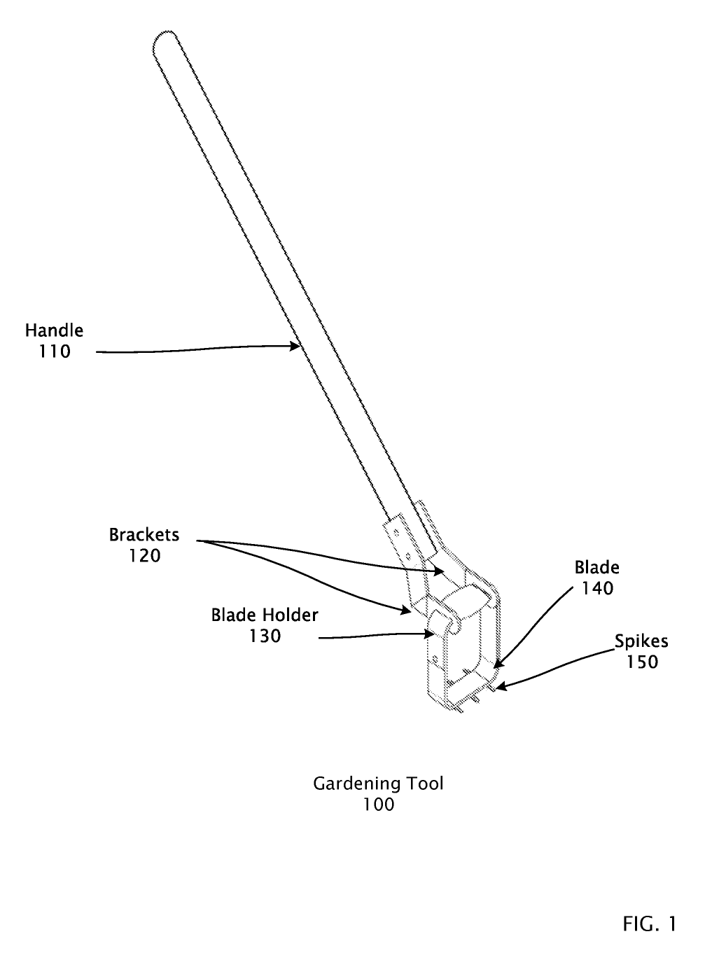

FIG. 1 is a perspective view of a Gardening Tool, according to one embodiment. In this example, Gardening Tool 100 may have an elongated shaft which may serve as a Handle 110. Handle 110 may be made in various sizes and shapes, such as oval, and out of a variety of materials, such as wood, plastic, rubber, metal, or carbon fiber. Handle 110 may include an ergonomic grip or cushion which may enhance friction and comfort for a user's hands.

Handle 110 may connect to Brackets 120, which may be offset at any angle such as approximately 45°, for example, in relation to Handle 110. Openings at the base of Brackets 120 may receive and secure Blade Holder 130. Blade Holder 130 may connect to the top of Blade 140. Blade 140 may comprise a detachable U-shaped, double-edged blade. Blade 140 may oscillate at any angle, for example, 8° to 12° relative to Brackets 120, upon pushing and pulling motions of Gardening Tool 100. The oscillation of Blade 140 may facilitate the loosening of soil or removal of weeds, roots, debris, or any other matter at or below the surface of the earth.

Blade 140 may contain a plurality of Spikes 150, which may run along the length of the base of Blade 140, for example. Spikes 150 may also extend beyond the length of the base of Blade 140. Spikes 150 may allow Gardening Tool 100 to penetrate the earth at a deeper level or plane than conventional gardening tools such as gardening hoes, for example, and thus improve labor efficiency.

Having multiple points of contact, Spikes 150 and Blade 140, may also improve efficiency in removing roots and other matter at the level of Blade 140.

A person skilled in the art will understand that any part of Gardening Tool 100 may be made in various shapes and sizes, and out of various materials, such as wood, plastic, rubber, metal, or carbon fiber, or combinations thereof.

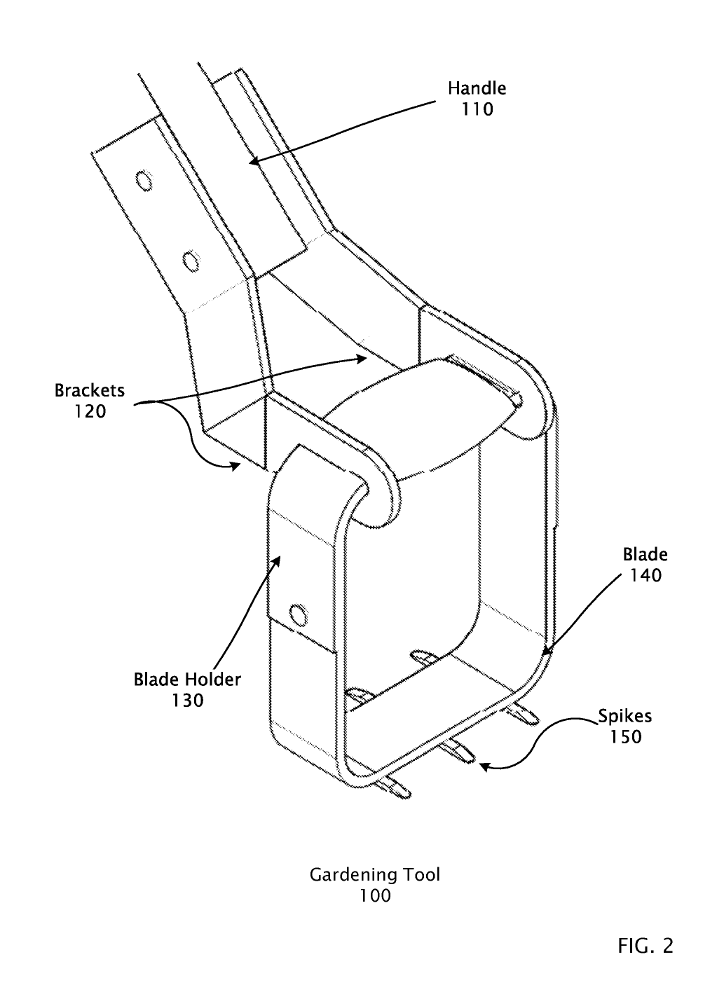

FIG. 2 is a perspective view of the head of a Gardening Tool 100, according to the first embodiment. Height 160 may be approximately four inches.

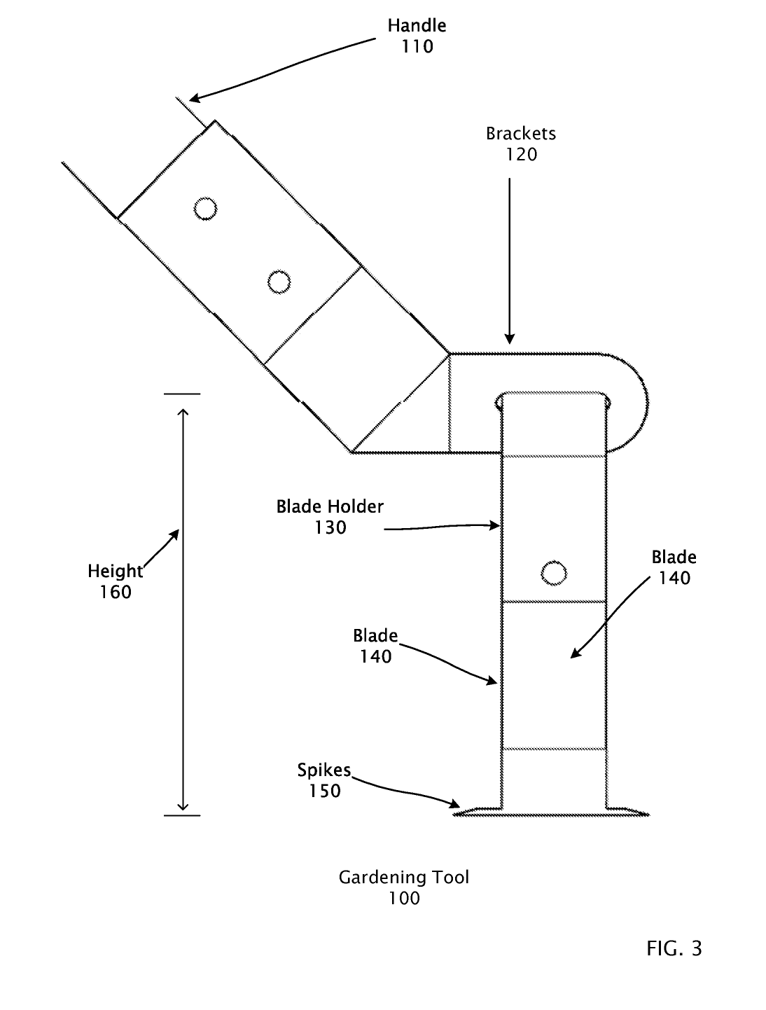

FIG. 3 is a side view of a Gardening Tool, according to the first embodiment. In this example, Handle 110 may connect to Brackets 120, which may be offset at an approximate 45° angle relative to Handle 110. The size of the opening at the base of Brackets 120 and the width of Blade Holder 130 may be designed so as to allow Blade 140 to oscillate at an angle of approximately 8° to 12°, relative to the resting position of Blade 140 on Brackets 120. A combined Height 160 of Blade Holder 130 and Blade 140 may be approximately four (4) inches, and Blade 140 may be approximately three and one quarter (3¼) inches wide.

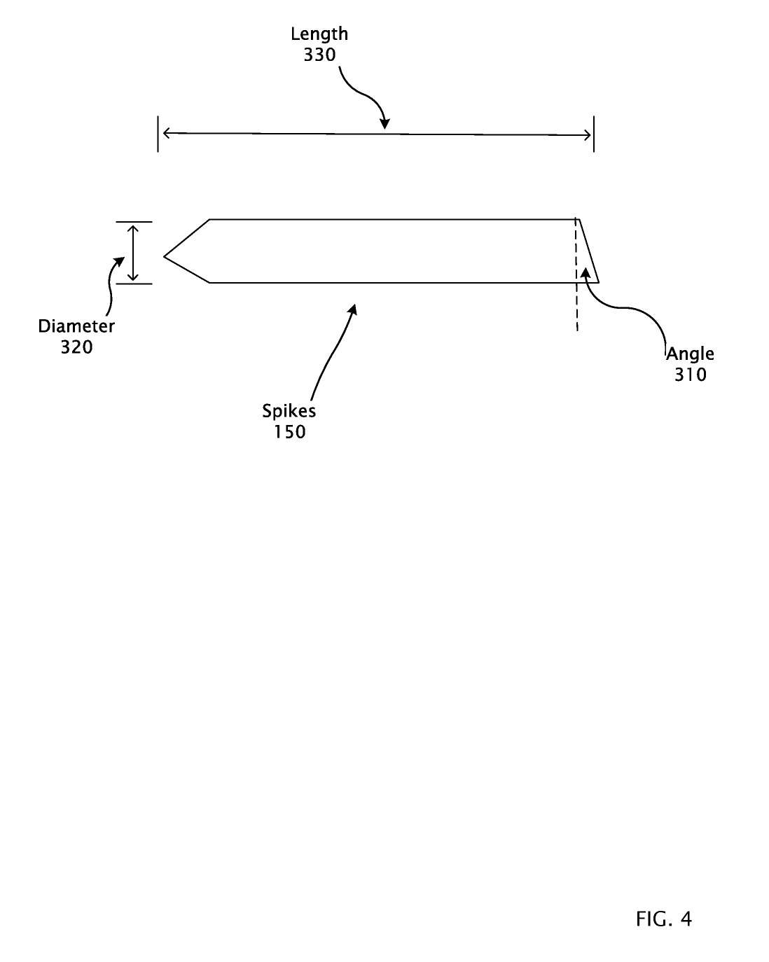

FIG. 4 is a view of a Spike 150 according to the first embodiment. Spikes 150 may have a diameter of approximately one-eighth (⅛) to five-thirty-seconds ( 5/32) of an inch. Angle 310 may be approximately 30° to 40°, which may allow Gardening Tool 100 to loosen soil ahead of Blade 140, and at a deeper level or plane. As Blade 140 oscillates, Spikes 150 may work down into soil, loosening lower levels and making it easier to remove weeds. Spikes 150 may have Length 330 of approximately two to two and one eighth inches.

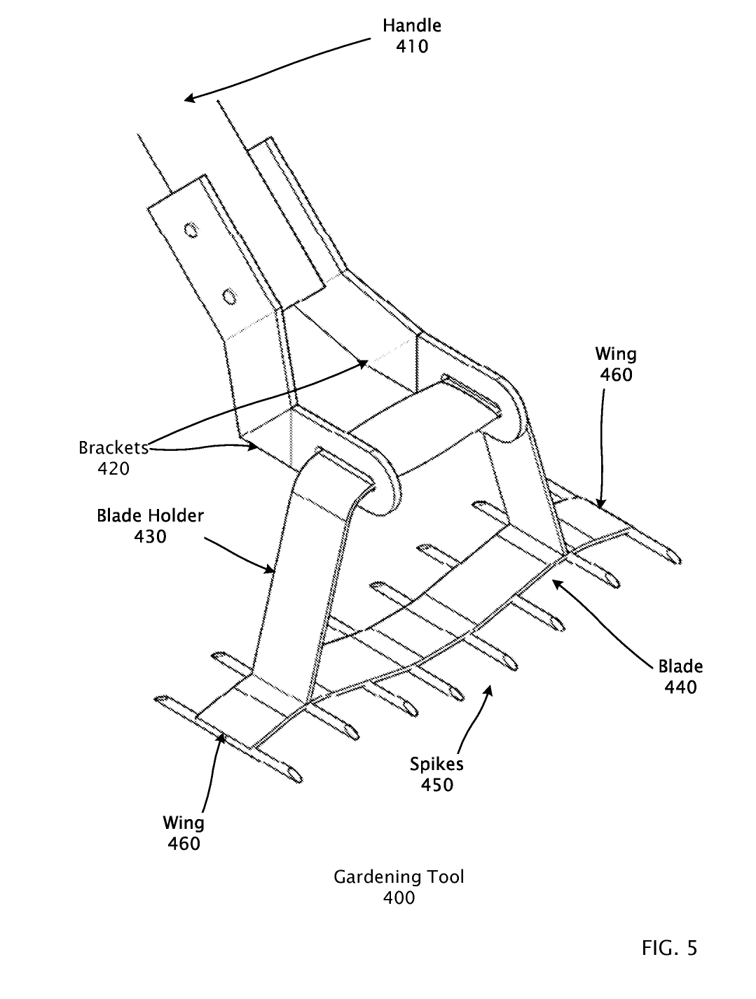

FIG. 5 is a perspective view of Gardening Tool 400, according to a second embodiment. In this example, Gardening Tool 400 may have an elongated Handle 410 which may connect to Brackets 420. Openings at the base of Brackets 420 may receive and secure Blade Holder 430. Blade Holder 430 may connect to Blade 440. Blade 440 may comprise a blade with wave lengths, for example, approximately four inches long. Blade 440 may extend beyond Blade Holder 430 to form Wings 460.

Blade 440 also contain a plurality, four to eight for example, of Spikes 450 along its length.

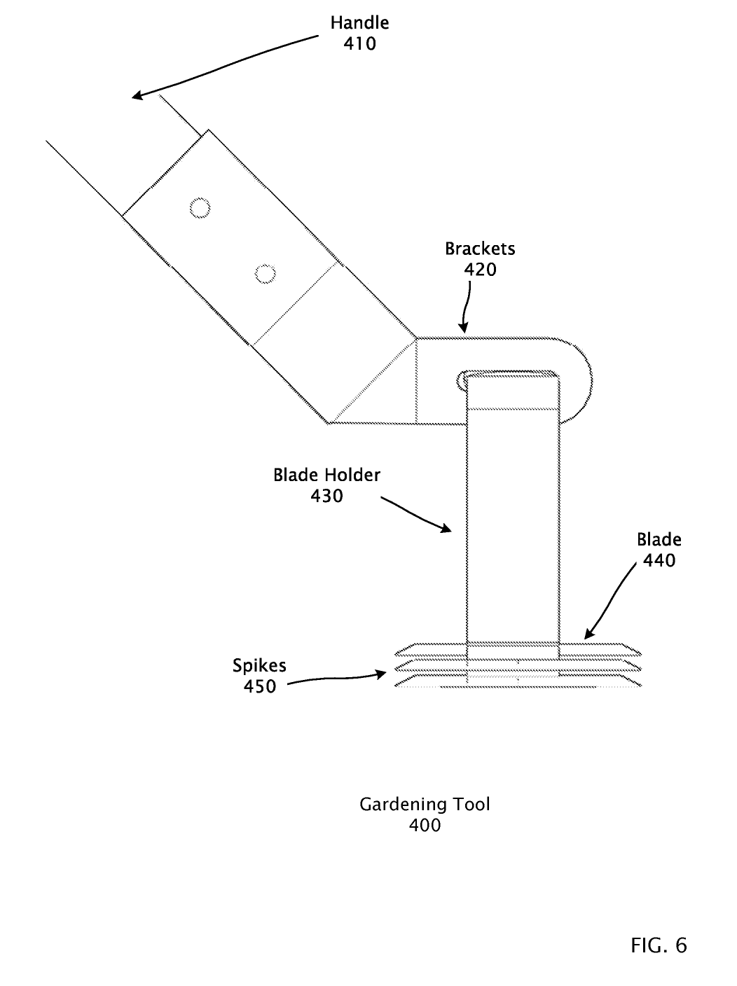

FIG. 6 is a side view of a Gardening Tool 400, according to the second embodiment. Brackets 420 may be offset at any angle such as approximately 45°, for example, in relation to Handle 410.

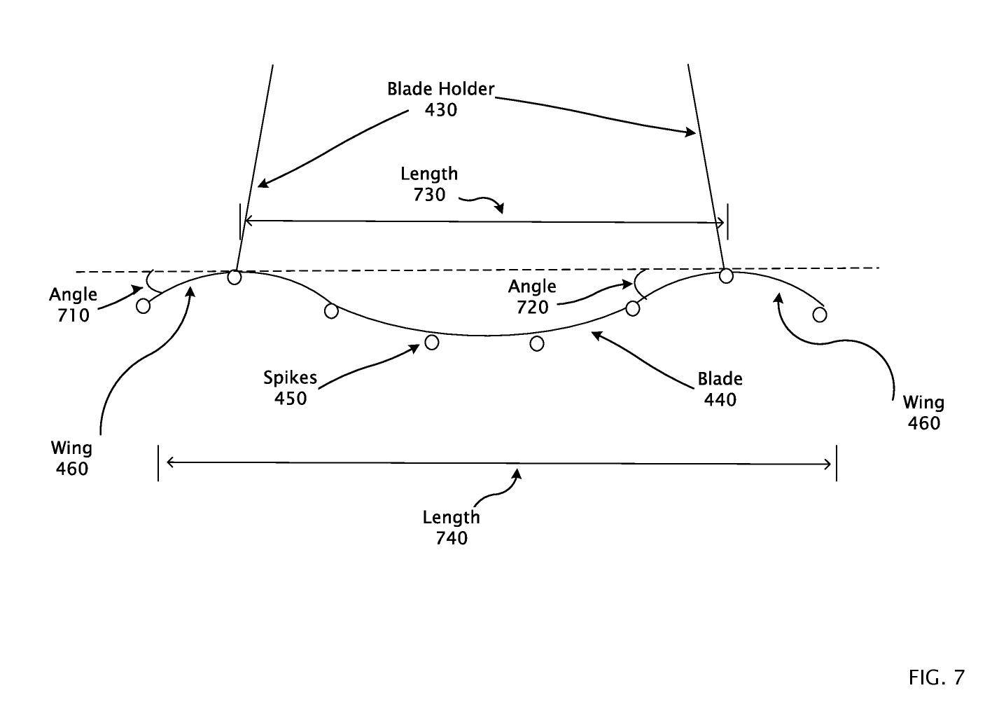

FIG. 7 is a front view of Blade 440 of Gardening Tool 400, according to the second embodiment. Blade 440 may form Angle 720 of approximately 10° to 13° from horizontal. Wings 460 may form Angle 710 of approximately 20° to 25°. Length 730 of Blade 440 may be approximately 5 11/16 inches, while Length 740 of Blade 440 and Wings 460 may be approximately 8 inches.

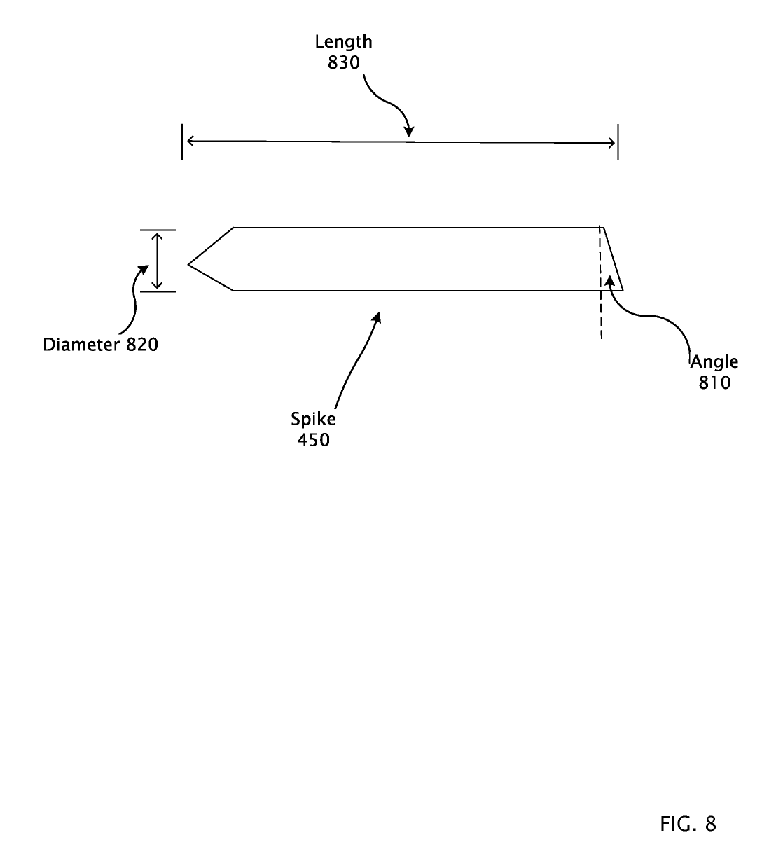

FIG. 8 is a view of a Spike 450 according to the first embodiment. Spikes 450 may have a diameter of approximately one-eighth (⅛) to five-thirty-seconds ( 5/32) of an inch. Angle 810 may be approximately 30° to 40°, which may allow Gardening Tool 400 to loosen soil ahead of Blade 440, and at a deeper level or plane. As Blade 440 oscillates, Spikes 450 may work down into soil, loosening lower levels and making it easier to remove weeds. Spikes 450 may have Length 830 of approximately two to two and one eighth inches.

1. A gardening tool, comprising:
an elongated shaft at its first end;
a head at its second end,
the head comprising a blade;
an attachment means to connect the elongated shaft to the head.

2. The gardening tool of claim 1, wherein the elongated shaft is composed of any materials from the list containing wood, plastic, rubber, metal, or carbon fiber.

3. The gardening tool of claim 1, wherein the head includes a U-shaped blade.

4. The gardening tool of claim 1, wherein the head includes a double-edged blade.

5. The gardening tool of claim 1, wherein the head includes a detachable blade.

6. The gardening tool of claim 1, wherein the head includes a plurality of spikes on the main body of the blade.

7. The gardening tool of claim 1, wherein the head includes a plurality of spikes which extend beyond the main body of the blade.

8. The gardening tool of claim 1, wherein the blade comprises a wavy shape.

9. The gardening tool of claim 1, wherein the attachment means to connect the elongated shaft to the head comprises a bracket offset at an approximately 45° angle.

10. The gardening tool of claim 1, wherein the head is composed of any materials from the list containing wood, plastic, rubber, metal, or carbon fiber.
